(19) United States
(12) Patent Application Publication
(10) Pub. No.: US 2005/0045773 A1
(43) Pub. Date: Mar. 3, 2005

(54) System for ejecting a spin-stabilized space flying body

(76) Inventors: Christian Bank, Bremen (DE); Hans-Georg Kolloge, Wildeshausen (DE)

Correspondence Address: FASSE PATENT ATTORNEYS, P.A., P.O. BOX 726, HAMPDEN, ME, 04444-0726, US

(21) Appl. No.: 10/922,365

(22) Filed: Aug. 19, 2004

(30) Foreign Application Priority Data
Aug. 19, 2003 (DE) 103 37 973.8

(51) Int. Cl. B41J 29/38

(52) U.S. Cl. 244/161

(57) ABSTRACT

A spacecraft or space flying body is spin-stabilized as the body is expelled from an ejection tube, for example from a larger spacecraft. For imposing spin stabilization on the flying body, a guide groove is provided between an outer wall of the flying body and an inner wall of the ejection tube. The guide groove has at least partly a helical slope. Guide spheres or balls travel in the guide groove as the flying body is driven by a drive, such as a spiral spring or an electric motor, out of the ejecting tube.

### PRIORITY CLAIM

This application is based on and claims the priority under 35 U.S.C. §119 of German Patent Application 103 37 973.8, filed on Aug. 19, 2003, the entire disclosure of which is incorporated herein by reference.

### FIELD OF THE INVENTION

The invention relates to launching a spin-stabilized flying body capable of traveling in outer space, either manned or unmanned, either propelled or unpropelled.

### BACKGROUND INFORMATION

It is known to eject space flying bodies from a spacecraft, particularly a space station. A drive imposes a driving force on the body to be ejected. The driving force comprises a rotational component for imposing a spin on the flying body as the flying body is ejected and a translatory component for propelling the flying body in a travel direction out of an ejecting tube.

Heretofore ejecting mechanisms for such flying bodies have been developed for use in satellites, for example in so-called spy satellites for the ejection of return capsules for carrying exposed film material back to earth. Flying bodies for these purposes have relatively small dimensions and a respectively small mass. Other ejection systems have been developed for the ejection of smaller satellites from the space shuttle, for example. Such flying bodies, for example communication satellites or miniature satellites are stabilized or spin-stabilized relative to a central rotational axis. Space communication satellites are flying bodies having significantly large dimensions, for example with diameters larger than 2.5 m and a correspondingly large mass. So-called miniature satellites are flying bodies having smaller dimensions and accordingly a smaller mass. In both instances the ejection of these larger or smaller satellites or flying bodies was performed from an ejection tube that was not pressurized. The requirements regarding the precise directional orientation of these flying bodies or satellites to be ejected have been relatively small since once ejected these flying bodies or satellites are capable of performing a closed loop control regarding their positional or directional orientation.

Similar ejection devices have been developed for re-entry capsules having dimensions between those of communication satellites and miniature satellites. Each of these ejection devices has a mechanism for first rotating the flying body to be ejected to impose a spin stabilization and to then impose an acceleration force for the ejection. These mechanisms are installed in the injecting container or tube and include motors, spring operated pressure devices, or so-called explosion chords. Conventional ejection devices also comprise means for holding and guiding the flying body to be ejected from the ejecting tube.

In connection with the so-called orbital payload retrieval system (OPRS) an ejection mechanism has been suggested which must be made ready by the astronauts onboard of the international space station (ISS). The astronauts must handle an ejection mechanism, more specifically they must install the ejection mechanism, test the mechanism, and make it ready for the ejection.

All of the above described conventional ejection systems have a substantial disadvantage of a relatively high weight and a complex construction. Another disadvantage is particularly seen in the use of explosives in manned orbital missions and/or the use of strong spiral springs. Explosives and strong spiral springs are prone to cause injuries when an erroneous release or triggering should take place, thereby exposing astronauts to risk of injury where the astronauts are in positions close to the ejection tube or when they have to prepare such tubes for launching.

### OBJECTS OF THE INVENTION

In view of the foregoing it is the aim of the invention to achieve the following objects singly or in combination:
to construct an ejection system or mechanism in such a way that it has an inherent safety characteristic while simultaneously having a lightweight and a reliable function;
to construct an ejection tube in such a way that an exact, predeterminable combination of translatory and rotational energy components are imparted onto the space flying body as it is being ejected; and
to construct such an ejection mechanism so that risks of injury to astronauts are substantially eliminated.

### SUMMARY OF THE INVENTION

The invention further aims to avoid or overcome the disadvantages of the prior art, and to achieve additional advantages, as apparent from the present specification. The attainment of these objects is, however, not a required limitation of the present invention.

The above objects have been achieved according to the invention by an apparatus for ejecting a spin-stabilized flying body, for example a body to be launched from a spacecraft, said body having an outer body wall, wherein the apparatus comprises an ejecting tube including an inwardly facing tube wall and means between the outer body wall and the tube wall for holding and guiding the spin-stabilized flying body in the ejecting tube and out of the ejecting tube. The means for holding and guiding comprise a guide track between the outer body wall of the flying body and the inwardly facing tube wall. Bearing balls are movably held in the guide track which has a helical slope around an ejection direction. The apparatus also includes a drive for spin-stabilizing and propelling the flying body out of the ejection tube. The drive imparts a torque moment to the flying body for spin-stabilizing the flying body. The guide track in cooperation with the bearing balls divides the torque moment into a rotational component and a translatory component.

According to the invention the torque moment is imposed on the flying body either by a torque spring or by an electric motor, whereby a rotational motion or force is divided into a rotation and a translatory motion component for imposing the spin stabilization on the flying body and for imposing an ejecting force respectively on the flying body. For this purpose, a mechanical coupling is provided between these two motion components by the guide track or guide groove and the entraining balls or spheres which are rotatably supported and guided in these guide tracks or grooves.

The just described construction of the apparatus according to the invention has a number of advantages compared to the prior art because the invention avoids the use of explosives in a manned spaceship or station, whereby a substantial accident potential has been eliminated for the astronauts. Another advantage is seen in that the weight or volume of the mechanical components for the imposition of spin stabilization and translatory motion components have been minimized, whereby the total mass of the space flight system has been decreased and the payload volume has been increased. Other advantages are seen in the simplicity of the present ejection mechanism by reducing the number of required mechanical and electrical functional components. Moreover, the fewer these components, the better is the reliability and the efficiency of the present system. Particularly, the embodiment with a torque spring does not require any electrical energy for the ejecting, that otherwise would have to be provided by the spacecraft or space station or by the space capsule itself. Thus, special requirements regarding a high current power supply are avoided in the spacecraft or space station or in the flying body itself where the driving force or energy is stored in the torque spring.

By making the initial section of the guide track or groove without any helical rise, slope or pitch it is assured that the beginning of the rotational acceleration starts substantially without any initial resistance to such rotational acceleration, whereby the efficiency of the energy transmission to the flying body is substantially improved. The initial section of the guide track or groove is preferably less than a full term and this section merges gradually into the groove section that has a slope or pitch that rises in accordance with the structural requirements of the particular system.

The use of a torque spring for the spin stabilization and for the propelling in a translatory direction has the further advantage that the torque spring does not need to be cocked on the ground. Cocking of the torque spring can be performed just prior to the launching of the flying body from the space ship or space station by leading a central winding shaft of the torque spring through the bottom of the ejecting tube so that this shaft is accessible for cooperation with a suitable torquing tool such as a torque wrench. This cocking of the torque spring can be performed directly prior to the ejecting or return mission of the flying body. As a result, the entire mechanism, prior to preparing the ejection, is free of energy that could otherwise be accidentally released by an astronaut. This feature eliminates the possibility of injury to the astronauts for all practical purposes. The cocking of the spring just prior to launching of the flying body can be further improved by providing a reduction gear between the torsion spring and the flying body.

According to the invention the guide spheres or balls are not held in a bearing cage. Rather, these spheres are free to travel along the guide track or guide groove. However, in order to avoid ejecting the guide spheres or balls into outer space as the flying body is launched, a ball trap is positioned at the end of the guide track or groove. A plurality of such ball traps may be provided, for example in the form of a so-called worm labyrinth. These ball traps make sure that the guide balls are retained in the spacecraft or station.

According to another advantageous embodiment of the invention the air pressure available in the spacecraft or space station can be used partially or completely for imposing an ejecting force onto the flying body in the ejecting tube by providing the bottom of the ejecting tube with an openable inlet that communicates the interior of the spacecraft or space station with an air chamber in the ejecting tube. These holes may be used in addition to or instead of a torque spring which is also installed in the bottom area of the ejecting tube.

### BRIEF DESCRIPTION OF THE DRAWINGS

In order that the invention may be clearly understood, it will now be described in connection with example embodiments thereof, with reference to the accompanying drawings, wherein:

FIG. 1A is a perspective view of a cut open ejecting tube according to the invention;

FIG. 1B shows a perspective view of a flying body just propelled out of the ejection tube;

FIG. 2 shows an enlarged sectional view through the ejection tube with a portion of a flying body positioned inside the ejection tube; and

FIG. 3 illustrates a view into the bottom part of the ejection tube cut open at its bottom end.

### DETAILED DESCRIPTION OF PREFERRED EXAMPLE EMBODIMENTS AND OF THE BEST MODE OF THE INVENTION

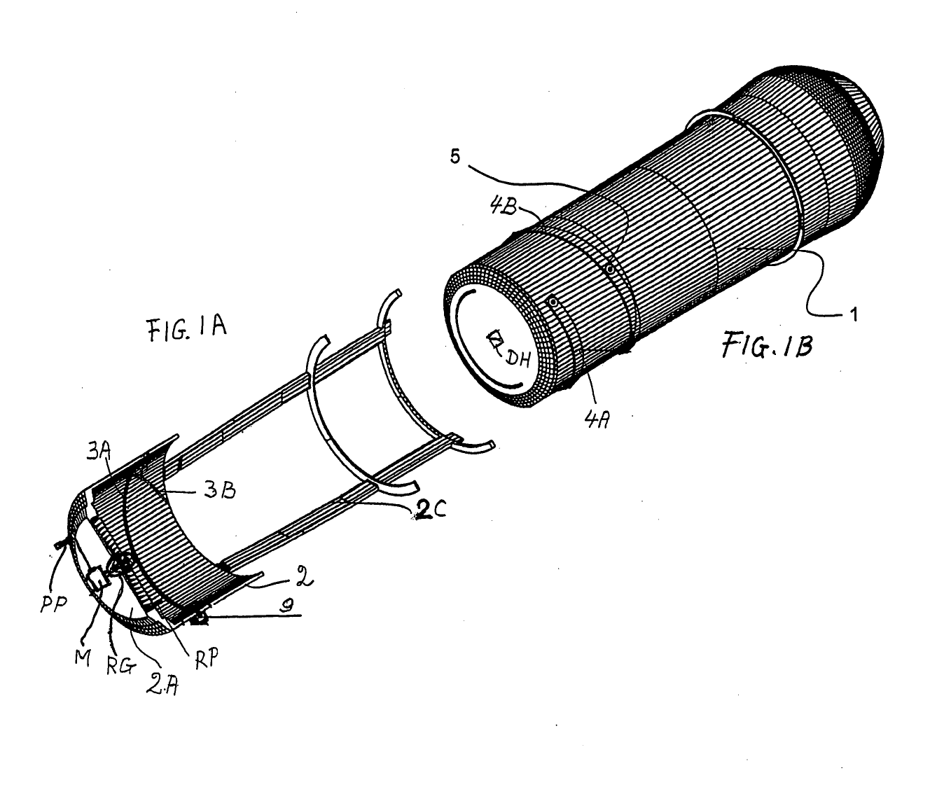

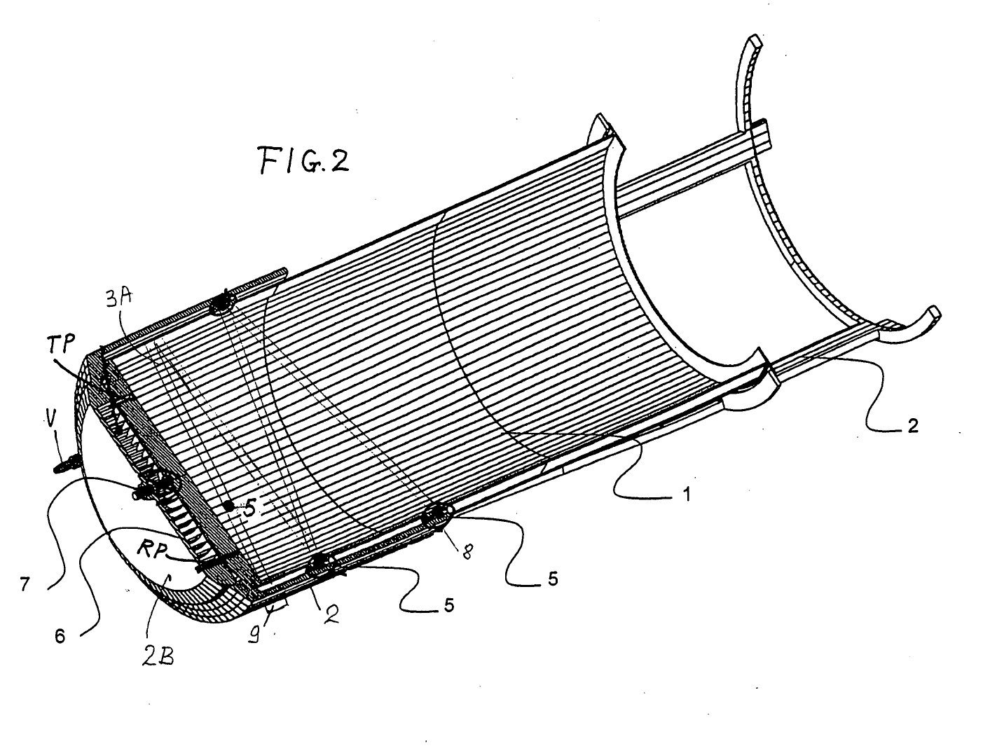

FIG. 1A shows an ejection tube 2 with a bottom chamber 2A from which a cover 2B shown in FIG. 2 has been removed. For weight reduction purposes, the ejecting tube is constructed as short as possible. For the same purpose a guide frame 2C is connected to the ejecting tube 2. The ejection tube 2 has an inwardly facing tube wall provided with a guide track or groove section 3A and a further guide track or groove section 3B. The flying body 1 comprises a corresponding first guide track or groove section 4A and a second guide track or groove section 4B. A drive hole DH for engagement by a withdrawable and rotatable drive pin of a motor M or of a reduction gear RG is provided in the bottom of the flying body 1 as shown in FIG. 1B.

Guide balls or spheres 5 are movable in the guide tracks or grooves 3A, 3B and 4A and 4B. The guide ball 5 in FIG. 1B is shown only for illustration purposes because according to the invention the balls 5 are retained in the ejecting tube 2 as will be described in more detail below. During an ejection the balls or spheres 5 function simultaneously as support bearings and as guide balls. According to the invention these balls can freely travel in the guide grooves or tracks provided on or in the inner tube wall of the ejection tube 2 and/or on or in the outer body wall of the flying body 1.

FIG. 1A shows that a reduction gear RG is interposed between the output of the electrical motor M that receives its power through a power plug PP in the bottom of the ejection tube 2. The reduction gear RG is equipped with an output drive pin not seen in FIG. 1A, but fitting into the drive hole DH of the flying body 1. As the flying body begins to move axially the drive pin is withdrawn from the drive hole DH.

Normally the balls 5 are stored in a ball container 9 provided in the wall of the ejection tube 2. This container 9 may also include a ball arrester for holding a ball in place prior to launching.

FIG. 2 is a view similar to that of FIG. 1A, however on an enlarged scale and shows a modified embodiment according to the invention in which the drive with a motor and a reduction gear has been replaced by a torque spring drive with a torque spring 6. The torque spring 6 is a spiral spring rather than a helical spring. The spiral spring 6 is equipped with a torquing or wind-up central shaft 7 that projects through an opening in the bottom cover 2B of the ejection tube 2 for engagement with a torquing tool such as a torquing wrench not shown. A retaining pin RP normally prevents rotation of the flying body 1 relative to the ejection tube 2 for winding up or cocking the torque spring 6. The retaining pin RP can be withdrawn through the bottom cover 2B for releasing the torque moment stored in the torque spring 6 to thereby impart a rotational driving force on the flying body 1. The cooperation of the guide tracks or grooves 3A, 3B and the guide tracks or grooves 4A, 4B with the balls 5 divides the rotational energy imparted by the torque spring 6 into a rotational component and a translatory axial component for imposing a spin and for expelling the flying body 1 out of the ejection tube 2. A torquing pin TP connects the outer end of the torque spring 6 with the bottom of the flying body 1. As the flying body 1 begins to move axially the torquing pin TP is automatically withdrawn from a hole in the bottom of the flying body 1 since the torquing pin TP is rigidly connected to the outer end of the torque spring 6. The embodiment or the drive of FIG. 2 has the advantage that no electrical power is required from the spacecraft or space station because a torquing wrench may be applied for mechanically winding up the torque spring 6. This operation may be done immediately prior to the ejection of the flying body 1 so that normally the spring 6 is not under tension and hence not a source of injury. As in FIG. 1A, a reduction gear may be inserted between the torquing pin or shaft 7 and the torque spring 6.

In addition to the torque spring 6 or instead of the torque spring 6 the flying body 1 may be expelled from the tube 2 by opening a valve V in the bottom of the ejecting tube 2 to thereby communicate the bottom chamber 2A with the air in the spacecraft or spaceship to provide air pressure that is normally sufficient for ejecting the flying body 1.

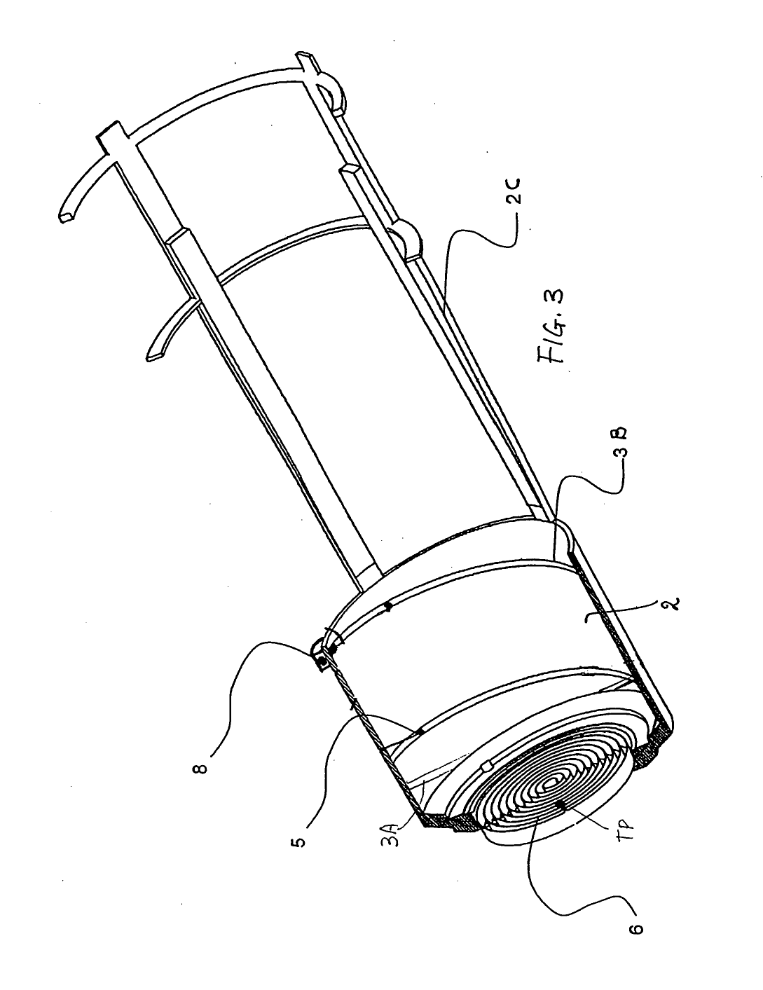

FIG. 2 also shows a ball trap 8 for retaining the balls in the ejection tube 2 when the flying body 1 leaves the tube 2. Such ball traps 8 may be constructed, for example as a worm labyrinth. At least one such ball trap 8 is positioned at the axially outer end of the ejection tube 2 as shown in FIG. 3. The ball trap or ball traps make sure that the balls 5 do not escape into outer space where they could potentially be a danger to other spacecraft or flying bodies. The ball traps 8 make sure that the balls 5 are retained in the spacecraft or space station.

FIG. 3 illustrates a perspective view of the torque spring 6 positioned in the bottom chamber 2A of the ejection tube 2. In operation, either the electric motor is started or the torque spring 6 is cocked or wound up, whereby the torque pin TP that reaches releasably or withdrawably into a hole in the bottom of the flying body 1 imparts a torque moment to the flying body 1. The guide balls 5 start moving in the guide grooves or tracks 3A, 3B and 4A, 4B. The guide balls 5 convert the torque moment partially into a translatory moment that expels the flying body 1 from the ejecting tube 2. The ratio between the rotation energy component and the translatory energy component imparted on the flying body 1 can be precisely selected by selecting the slope or pitch of the guide grooves or tracks 3A, 3B, 4A, 4B. This slope or pitch of the guide grooves or tracks 3A, 3B and 4A, 4B cooperates with the balls 5 so that the required spin stabilization is imposed on the flying body 1 while simultaneously imparting a sufficient ejecting force for expelling the body 1 from the ejecting tube 2.

Once the electric motor is started or the torque spring 6 has been wound up, the ejection is triggered by withdrawing the retaining pin RP which, as shown in FIG. 2, extends, for example from the bottom of the ejection tube 2 into the bottom of the flying body 1. Alternatively, the retaining pin may also be positioned to reach radially into the guide grove 4A of the flying body. The withdrawal of the retaining pin RP can, for example be accomplished with a nonexplosive paraffin actuator which can be activated by melting without any impact and with a very low energy requirement.

The slope or pitch of the guide groves 3A, 3B, 4A and 4B is predetermined in such a way that an exactly defined ratio is accomplished between the rotational and translatory energy. As a result an optimal speed ratio between rotational and translatory motion of the flying body 1 is also assured instantly for the required spin stabilization and expulsion.

In the described example embodiment it is preferred that the slope or pitch of the first guide track or grooves 3A, 4A is very small or even zero to thereby begin the rotation of the flying body 1 substantially without any initial resistance, whereby the efficiency of the energy transfer is substantially increased. The low or zero pitch of the initial guide groove sections 3A, 4A gradually merges into the second guide groove sections 3B and 4B which have the required pitch for assuring the above mentioned proper ratio or optimal ratio between the rotational and translational energy division to provide the required spin stabilization for the flying body 1.

By opening the valve V shown in FIG. 2, air under pressure in the spacecraft or space station can be introduced into the chamber 2A that is closed by the bottom cover 2B. By a proper dimensioning and control of the valve V it is possible to either introduce a portion of the cabin pressure or the entire cabin pressure into the chamber 2A to thereby accelerate the flying body to be ejected. Preferably the pressurization with the cabin pressure cooperates with the operation of the torque spring 6 shown in FIG. 2.

As described, the guide track sections 3A, 3B, 4A and 4B have portions in or on the inwardly facing tube wall surface of the ejecting tube 2 and on or in the outwardly facing body wall of the flying body 1. However, this construction may be modified by providing the guide track entirely in or on the inwardly facing tube wall surface of the ejection tube 2 or entirely in or on the body wall of the outer surface of the flying body 1.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. An apparatus for ejecting a spin-stabilized flying body (1) having an outer body wall, said apparatus comprising an ejecting tube (2) including an inwardly facing tube wall, means between said outer body wall and said inwardly facing tube wall for holding and guiding said spin-stabilized flying body in said ejecting tube, said means for holding and guiding comprising a guide track (3, 4) between said outer body wall and said tube wall, bearing balls (5) movable in said guide track (3, 4), said guide track (3, 4) having a helical slope around an ejection direction, said apparatus further comprising a drive for spin-stabilizing and propelling said flying body out of said ejecting tube (2).

2. The apparatus of claim 1, wherein said guide track is a helical groove (3) in said inwardly facing tube wall.

3. The apparatus of claim 1, wherein said guide track is a helical groove (4) in said outer body wall of said flying body (1).

4. The apparatus of claim 1, wherein said guide track is a guide groove having a first guide groove section next to a bottom of said ejecting tube and a second guide groove section more remote from said bottom of said ejecting tube than said first guide groove section, said first guide groove section having a first slope, said second guide groove section having a second slope larger than said first slope.

5. The apparatus of claim 4, wherein said first slope is zero.

6. The apparatus of claim 4, wherein said guide groove is a helical guide groove having a slope that increases in a direction away from said bottom of said ejecting tube (2).

7. The apparatus of claim 1, wherein said guide track is a guide groove comprising at least one ball box (8) at least at one end of said guide groove for entrapping said bearing balls (5) to keep said bearing balls from escaping out of said ejecting tube (2).

8. The apparatus of claim 1, wherein said drive comprises a torsion spring (6).

9. The apparatus of claim 8, wherein said torsion spring (6) comprises a shaft (7) rotatably mounted in said ejecting tube (2) for cocking said torsion spring (6).

10. The apparatus of claim 9, wherein said shaft (7) for cocking passes through a bottom (2A) of said ejecting tube (2) for cooperation with a tool for said cocking.

11. The apparatus of claim 1, further comprising a reduction gear operatively interposed between said drive and said spin-stabilized flying body (1).

12. The apparatus of claim 1, wherein said drive comprises an electric motor (M) operatively connected to said spin-stabilized flying body.

13. The apparatus of claim 1, wherein said drive comprises an air chamber in said ejection tube below said flying body (1) and an inlet into said air chamber for communicating said air chamber with an air pressure in a spacecraft for expelling said spin-stabilized flying body (1) out of said ejecting tube (2).

14. The apparatus of claim 13, wherein said ejecting tube (2) comprises a bottom cover for closing said air chamber and at least one openable valve (11) in said bottom cover for forming said inlet admitting spacecraft cabin air into said air chamber.

15. The apparatus of claim 1, further comprising a removable retaining pin (RP) for normally retaining said flying body (1) in said ejecting tube (2).
